(19) United States
(12) Patent Application Publication
(10) Pub. No.: US 2018/0110210 A1
(43) Pub. Date: Apr. 26, 2018

(54) FISHING ROD HOLDER APPARATUS

(71) Applicant: Michael Placko, Clifton, NJ (US)

(72) Inventor: Michael Placko, Clifton, NJ (US)

(21) Appl. No.: 15/334,599

(22) Filed: Oct. 26, 2016

(51) Int. Cl. A01K 97/10; B60R 9/08; B60R 9/06

(52) U.S. Cl. CPC A01K 97/10; B60R 9/06; B60R 9/08

(57) ABSTRACT

A fishing rod holder device holds and transports multiple rod sections on a truck bed. The rod holder device comprises a frame and rod receptors. The frame is removably attached to a front bed rail of a load bed of the truck. The frame fixedly attaches a set of rod receptors at a predefined inclination along the length of the frame, where each rod receptor is configured to house the rod section. The intermediate bar is fixedly attached across outer surface of each rod receptor, where another set of rod receptors are fixedly attached along the length of the intermediate bar at the predefined inclination. The predefined inclination of the rod receptors with the front bed rail defines a triangular orientation, where the triangular orientation is configured to increase the load bearing capacity of the frame.

### FIELD OF THE INVENTION

The present invention relates to storage devices for fishing rods during travel. More particularly the present invention relates to a fishing rod storage device which is used to store as well as transport fishing rods in the rear bed of a truck.

### BACKGROUND

Travelling with fishing rods or poles can be cumbersome, when it comes to the safe storage and transport of fishing rods during travel. This is because the delicate components of the fishing rods, which are carefully assembled and connected to each other, can be damaged if a user casually carries the unsecured fishing rods inside the truck bed. Fishermen may own multiple fishing rods which are required to be transported between various fishing spots. If the fishing rods are damaged during the travel, then the fisherman are forced to substitute or repair the damaged fishing rods to meet the fishing needs. This may incur both inconvenience as well as additional expenses to the fishermen since most of the fishing rods are expensive.

Most of the conventional fishing rod storage devices do not provide a safe storage environment. Further, once the fishermen arrive at the fishing spot, they usually spend some extra time searching through the fishing equipment and may spend a substantial amount of time connecting different components of their fishing rods that may have completely disconnected during the travel. Therefore, a modern fishing rod storage device is desired to counter such problems observed in the conventional fishing rod storage devices. However, even the modern fishing rod storage devices lacked the ability to carry a significant number of fishing rods simultaneously. Even if fishing rod storage devices provided multiple rod storage capability, they still lacked the load bearing capacity to carry the weight of multiple fishing rods which resulted in failure of such devices.

Therefore, there is a need for a fishing rod holder device which can overcome the above-mentioned problems, and provide a storage system which allows multiple fishing rod storage as well as extensive load bearing capacity, especially during travel.

### SUMMARY OF THE INVENTION

The rod holder device disclosed herein addresses the issue of providing a storage system which allows multiple fishing rod storage as well as extensive load bearing capacity, especially during vehicle travel. The rod holder device is configured to hold and transport multiple rod sections in the truck bed. The rod holder device comprises a frame and rod receptors. The frame is removably attached to a front bed rail of a load bed of the truck. The frame fixedly attaches a set of rod receptors at a predefined inclination along the length of the frame, where each rod receptor is configured to house the rod section. The intermediate bar is fixedly attached across the outer surface of each rod receptor, where another set of rod receptors are fixedly attached along the length of the intermediate bar at the predefined inclination. The predefined inclination of the rod receptors with the front bed rail defines a triangular orientation, where the triangular orientation is configured to increase the load bearing capacity of the frame.

In an embodiment, the frame comprises one or more attachment bars extending from a front bar, wherein the attachment bars are configured to be removably fastened to an upper section of the front bed rail. In an embodiment, the front bar is configured to fixedly attach the rod receptors in a first row. In an embodiment, the rod receptors are welded to the front bar and the intermediate bar. In an embodiment, the front bar and the intermediate bar are rectangular tubes. In an embodiment, each attachment bar is removably attached to the front bed rail of the load bed via a bolt assembly, where the bolt assembly comprises a bracket section and a bolt. The bracket section is fastened to the front bed rail, where the bracket section is configured to receive the attachment bar, and the bolt is inserted through the bracket section and the attachment bar to removably attach the attachment bar to the front bed rail.

In an embodiment, the intermediate bar is configured to fixedly attach the rod receptors in a second row. In an embodiment, the rod sections are spaced apart and arranged alternately across the first row and the second row to avoid contact between alternate rod sections. In an embodiment, the rod holder device further comprises a locking pin positioned at a bottom section of each rod receptor, where the locking pin is configured to lock the rod section within the rod receptor to avoid detachment from the rod receptor when the rod section is transported via the truck. In an embodiment, the rod receptors are aluminium tubes configured to receive and support the rod sections.

### BRIEF DESCRIPTION OF THE DRAWINGS

FIG. 1A exemplarily illustrates a side perspective view of a rod holder device positioned on a load bed of a truck.

FIG. 1B exemplarily illustrates a front perspective view of the rod holder device.

FIG. 1C exemplarily illustrates a side view of the rod holder device, showing triangular orientation of arrangement of the rod receptors.

FIG. 2 exemplarily illustrates a sectional view of the attachment bar fastened to the front bed rail of the load bed.

### DETAILED DESCRIPTION OF THE INVENTION

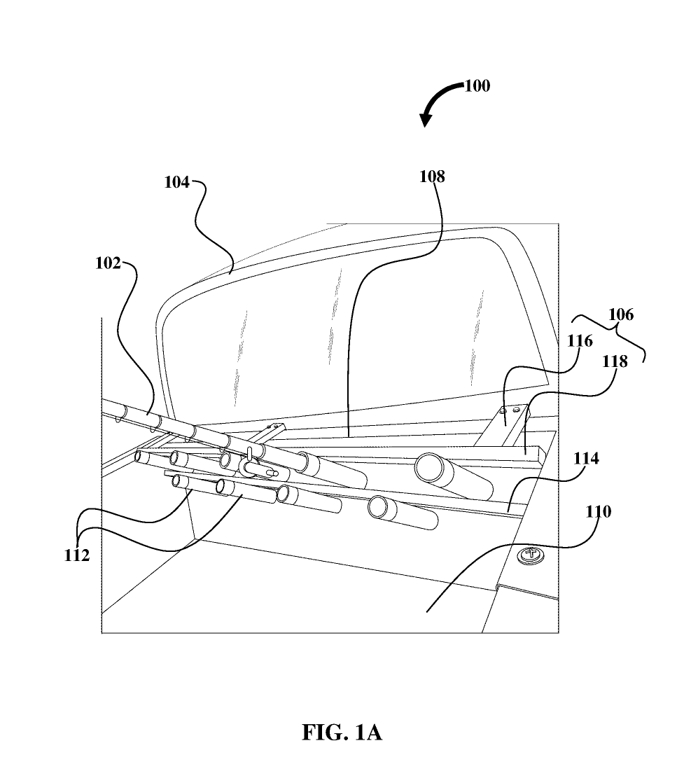

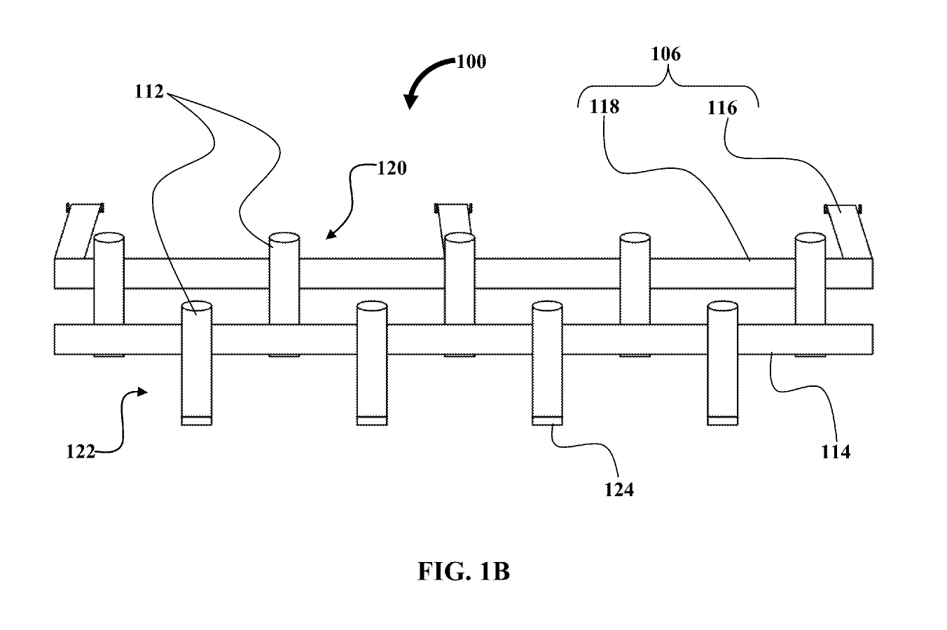

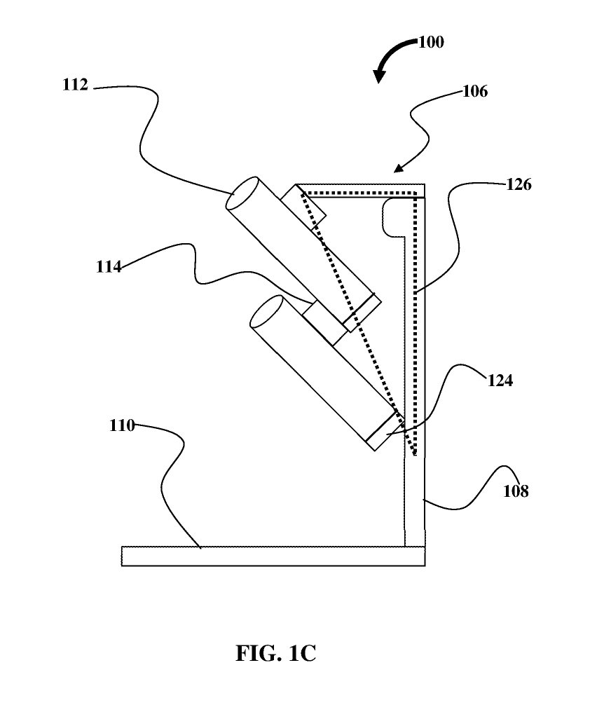

Referring to FIGS. 1A-1C, FIG. 1A exemplarily illustrates a side perspective view of a rod holder device 100 positioned on a load bed 110 of the truck 104, FIG. 1B exemplarily illustrates a front perspective view of a rod holder device 100, and FIG. 1C exemplarily illustrates a side view of a rod holder device 100, showing triangular orientation 126 of arrangement of the rod receptors 112. Referring to FIG. 1A, the rod holder device 100 is configured to hold and transport multiple rod sections 102 on a truck 104. The rod sections 102 disclosed here refers to ‘fishing rods 102’ which need to be carefully stored and transported from home to any fishing site, therefore the rod sections 102 hereinafter will be referred to as ‘fishing rods 102’. The rod holder device 100 comprises a frame 106 and rod receptors 112. The “rod receptors 112” disclosed here refers to hollow cylindrical cavities which are configured to receive and secure the handle portion of the fishing rods 102, for example, 2 inch round tubes.

The frame 106 is removably attached to a front bed rail 108 of a load bed 110 of the truck 104. The front bed rail 108 is a frontal raised section of the load bed 110 which would be just behind the driver's seat. The frame 106 fixedly attaches a set of rod receptors 112 at a predefined inclination along the length of the frame 106, where each rod receptor 112 is configured to house each fishing rod 102. The rod receptors 112 are welded across the length of the frame 106 to increase the durability of the rod holder device 100, since the welded joints provide additional strength and stability when the fishing rods 102 are assembled. The intermediate bar 114 is fixedly attached across outer surface of each rod receptor 112, where another set of rod receptors 112 are fixedly attached along the length of the intermediate bar 114 at the predefined inclination.

Referring to FIG. 1C, the predefined inclination, for example, 45 degrees, of the rod receptors 112 with the front bed rail 108 defines a triangular orientation 126, where the triangular orientation 126 is configured to increase the load bearing capacity of the frame 106. The triangular orientation 126 or the strength triangle enables the load from the fishing rods 102 to be gradually distributed across the frame 106. Therefore, the load of the fishing rods 102 are not supported by the frame 106 alone, but a substantial amount of the load is distributed through the sturdy front bed rail 108 as well, which increases the durability of the rod holder device 100.

In an embodiment, the frame 106 comprises one or more attachment bars 116 extending from a front bar 118, wherein the attachment bars 116 are configured to be removably fastened to an upper section of the front bed rail 108. The attachment bars 116 are, for example, 2 inch×1 inch aluminium rectangular tubing. Here, according to FIG. 1B, in an embodiment, the front bar 118 is configured to fixedly attach the rod receptors 112 in a first row 120, for example, five rod receptors 112 configured to store five fishing rods 102. In an embodiment, the rod receptors 112 are welded to the front bar 118 and the intermediate bar 114. In an embodiment, the front bar 118 and the intermediate bar 114 are rectangular tubes. The rectangular shape of the front bar 118 and the intermediate bar 114 allows more surface are of welding for attaching the rod receptors 112.

In an embodiment, the intermediate bar 114 is configured to fixedly attach the rod receptors 112 in a second row 122, for example, according to FIG. 1B, four rod receptors 112 are configured to store four fishing rods 102. Therefore, a total of nine fishing rods 102 can be stored on the embodiment of the rod holder device 100 disclosed here. In an embodiment, the fishing rods 102 are spaced apart and arranged alternately across the first row 120 and the second row 122 to avoid contact between alternate fishing rods 102. If the rod receptors 112 are arranged one below the other in the first row 120 and the second row 122, then any loose fishing lines hanging from corresponding fishing rods 102 might get entangled during the travel and may cause misalignment. The alternate arrangement of the rod receptors 112 in the two rows 120 and 122 avoid the entanglement problem related to the loose fishing lines while allowing the fishing rods 102 to be secured safely. Further, the alternate row arrangement, as mentioned above, makes it easy for a user to detach any fishing rod 102 from any row 120 or 122 without disturbing the corresponding fishing rods 102.

Referring to FIG. 1B, in an embodiment, the rod holder device 100 further comprises a locking pin 124 positioned at a bottom section of each rod receptor 112, where the locking pin 124 is configured to lock the fishing rod 102 within the rod receptor 112 to avoid detachment from the rod receptor 112 when the fishing rod 102 is transported via the truck 104. In an example, the locking pin 124 is a snap fit assembly where the user can simply insert the handle portion of the fishing rod 102 into the rod receptor 112 so that the handle portion snap fits and locks into position. In another example, the handle portion of the fishing rod 102 is inserted completely into the rod receptor 112 and rotated to fit within the rod receptor 112, where the locking pin 124 is inserted to provide a friction fit of the handle portion within the inner surface of the rod receptor 112. In an embodiment, the rod receptors 112 are aluminium tubes configured to receive and support the fishing rods 102.

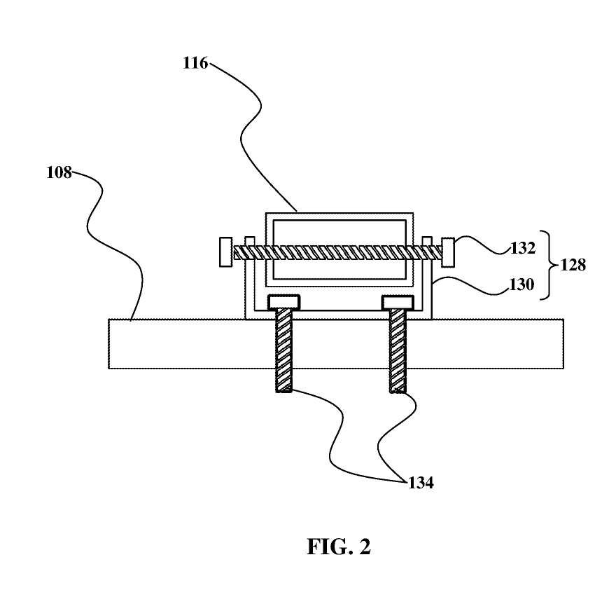

FIG. 2 exemplarily illustrates a sectional view of the attachment bar 116 fastened to the front bed rail 108 of the load bed 110 as shown in FIG. 1A. In this embodiment, each attachment bar 116 is removably attached to the front bed rail 108 of the load bed 110 via a bolt assembly 128, where the bolt assembly 128 comprises a bracket section 130 and a bolt 132. The bracket section 130 is fastened to the front bed rail 108 via multiple fasteners 134, where the bracket section 130 is configured to receive the attachment bar 116, and the bolt 132 is inserted through the bracket section 130 and the attachment bar 116 to removably attach the attachment bar 116 to the front bed rail 108.

The rod holder device 100 provides a suitable method to secure, transport and detachably remove fishing rods 102 from an automobile, for example, the pickup truck 104 as shown in FIG. 1A. The rod holder device 100 rotates and locks the fishing rods 102 to a locked position using the locking pin 124 to prevent the fishing rods 102 from being tilted around and getting damaged, predominantly during transport. In an optional example, a covering section can be positioned over the load bed 110 of the truck 104 to improve the safety of the fishing rods 102 by sealing them from external factors such as wind, or flying debris is dusty environments.

Considering the details mentioned above, the different rows enable the rod holder device 100 to secure multiple expensive fishing rods 102 during transport in the truck 104. The fishing rods 102 are positioned in an inclined manner to increase the load bearing capacity of the frame 106. However, even though the inclination is about 45 degrees, the inclination is not increased substantially more than 45 degrees to avoid the tip of the fishing rods 102 from being positioned above the height of the truck 104 which might cause the fishing rods 102 to become entangled with low hanging tree branches or other similar low hanging hindrances while driving the truck 104 on the road.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

I claim:

1. A rod holder device configured to hold and transport a plurality of rod sections on a truck, the rod holder device comprising;
a frame removably attached to a front bed rail of a load bed of the truck, the frame configured to fixedly attach a set of rod receptors at a predefined inclination along the length of the frame, wherein each rod receptor is configured to house the rod section; and
an intermediate bar fixedly attached across outer surface of each rod receptor, wherein another set of rod receptors are fixedly attached along the length of the intermediate bar at the predefined inclination, wherein the predefined inclination of the rod receptors with the front bed rail defines a triangular orientation, wherein the triangular orientation is configured to increase the load bearing capacity of the frame.

2. The rod holder device of claim 1, wherein the frame comprises one or more attachment bars extending from a front bar, wherein the attachment bars are configured to be removably fastened to an upper section of the front bed rail.

3. The rod holder device of claim 1, wherein the rod receptors are welded to the front bar and the intermediate bar.

4. The rod holder device of claim 2, wherein the front bar is configured to fixedly attach the rod receptors in a first row.

5. The rod holder device of claim 2, wherein the front bar and the intermediate bar are rectangular tubes.

6. The rod holder device of claim 2, wherein each attachment bar is removably attached to the front bed rail of the load bed via a bolt assembly, wherein the bolt assembly comprises;
a bracket section fastened to the front bed rail, wherein the bracket section is configured to receive the attachment bar; and
a bolt inserted through the bracket section and the attachment bar to removably attach the attachment bar to the front bed rail.

7. The rod holder device of claim 1, wherein the intermediate bar is configured to fixedly attach the rod receptors in a second row.

8. The rod holder device of claim 1, wherein the rod sections are spaced apart and arranged alternately across the first row and the second row to avoid contact between alternate rod sections.

9. The rod holder device of claim 1, further comprising a locking pin positioned at a bottom section of each rod receptor, wherein the locking pin is configured to lock the rod section within the rod receptor to avoid detachment from the rod receptor when the rod section is transported via the truck.

10. The rod holder device of claim 1, wherein the rod receptors are aluminium tubes configured to receive and support the rod sections.
